(19) United States
(12) Patent Application Publication
(10) Pub. No.: US 2014/0112499 A1
(43) Pub. Date: Apr. 24, 2014

(54) AUDIO PRODUCTION CONSOLE AND RELATED PROCESS

(71) Applicant: Yellow Matter Entertainment, LLC, Los Angeles, CA (US)

(72) Inventors: Steven Andrew Lintz, Los Angeles, CA (US); Alexander Charles Oana, Los Angeles, CA (US)

(73) Assignee: Yellow Matter Entertainment, LLC, Los Angeles, CA (US)

(21) Appl. No.: 14/061,652

(22) Filed: Oct. 23, 2013

Related U.S. Application Data
(60) Provisional application No. 61/717,420, filed on Oct. 23, 2012.

(51) Int. Cl. H04R 3/00

(52) U.S. Cl. CPC H04R 3/00
USPC 381/119

(57) ABSTRACT

The audio production console includes a touch-sensitive display cradled by a chassis that also includes a console panel and meter bridge. The touch-sensitive display includes an IR sensor perimeter and related circuitry for processing multi-touch events simultaneously and translating those events into parameter controls. The parameter controls are represented digitally on the display in a GUI reminiscent of traditional analog production console layouts. Software tracks movement of the digital parameter controls and works in conjunction with hardware to manipulate production audio as one or more on-screen parameters are adjusted by touching the display.

### BACKGROUND OF THE INVENTION

The present invention is directed generally to an audio production console and related process. More specifically, the present invention is directed to an audio production console replicating the traditional layout and functionality of an analog control-based console in a digital audio workstation having a multi-input touch screen interface with programmable audio control parameters, and process for using the same.

There are a variety of devices known in the art designed to control or manipulate various audio qualities in the audio production process. Such audio qualities may include, but are not limited to, volume level, localization, timbre, dynamics, routing, combining, monitoring, ambience and other effects that change the qualities of audio signals. Such devices are traditionally called mixers, consoles, mixing consoles, desks, mixing desks, boards, or sound boards. Such devices are used in many different applications, including recording studios, broadcasting, television, film post-production, live performances, etc.

An analog recording and mixing console works together with an audio source such as microphone, synthesizer, sampler, or audio recording device to provide user control over various audio qualities of the source. The analog recording or mixing console generally includes a series of electronic circuits coupled to a plurality of physical controls such as knobs, buttons, and sliders (or faders), built into and extending out from the console itself. Each control manipulates one audio parameter and may be hand manipulated individually or simultaneously. The physical recording console is fairly intuitive—rotation, depression, sliding, etc. of one or more of the controls causes a change in the qualities of the audio signal, depending on the parameter assigned to the manipulated control. In this respect, the hand manipulated control is typically closely connected to the circuit under its control such that the audio quality alterations track movement of the control. Another inherent function of analog consoles meant for recording studios is called monitoring. Monitoring controls audio sources and levels heard through speakers and sometimes headphones. The functionality of an analog console can be expanded by adding more physical circuits and controls. In this respect, the traditional audio control involved in contemporary audio production is quite large, expensive, and contains inherent physical circuitry limitations.

One major change in audio production over the last few decades is the transition from analog-based audio recording, production and playback equipment to digital-based devices. As such, digital audio consoles are designed to generally emulate the form and function of analog recording consoles, but instead work with digitized audio to exploit workflow, size, repeatability or compatibility benefits preferred in certain production settings. Digital audio consoles are able to process audio streams within the console itself or with other external hardware or software coupled thereto. Like analog consoles, digital consoles can provide dedicated control functionality. Unlike analog consoles, however, digital consoles have the added ability to vary and expand on the functionality of physical knobs and buttons. That is, the “soft keys” on a digital console are programmable and provide access to more control parameters with fewer physical input controls. This allows the digital console to control more audio channels and/or parameters than there are knobs or buttons. In some respects, digital consoles are advantageous over analog consoles in this regard.

A Digital Audio Workstation (“DAW”) is a type of advanced digital production console that is solely or primarily designed to record, mix, edit and/or playback digital audio. In this respect, a DAW controls audio parameters using computers and software that integrate or reproduce the functionality of a traditional mixing console, control surface, audio converter and data storage device. As such, the DAW can digitally emulate many analog recording console functions, such as level control, signal routing and combining, equalization and dynamics control. The DAW uses a Graphical User Interface (“GUI”) to display “controls” representative of parameters of a mixing console, recording device, audio editor, and other audio related controls on a computer monitor or other display device. Software-based GUIs are inherently adaptable. That is, the software does not include the same types of physical limitations commonly associated with tying one parameter with one physical knob, button, or slider/fader as traditionally used with analog consoles. Instead, DAW software can be programmed to do virtually anything—operate one or more parameters, change parameters on the fly, etc. This is certainly an enhancement over traditional analog mixing consoles that could only change the effect of a parameter by directly manipulating a physical control. A DAW may be controlled by a variety of intermediary devices, such as by a keyboard, mouse, trackball, or some other hardware input controller. The functionality of a DAW is highly expandable and limited only by the hardware/software limitations of the host computer. One problem with prior art DAWs, however, is the lack of intuitive control of the extensive parameters, which tends to adversely affect the overall functionality of a DAW. This is one reason that major recording artists still use analog production consoles.

The digital audio control surface of the DAW differs from the analog consoles in that the controls are manipulated in a digital environment as may be shown on a computer monitor or other electronic display device, such as a tablet. The digital control surface often resembles or mimics the appearance of an analog console, but the actual audio processing tasks are performed by the software and computer associated with the DAW. Although, some digital audio control surfaces may provide control over audio monitoring or other elements of audio production functionality. Through the digital audio control surface, users can control hardware parameters and tasks processed by the DAW. In this respect, the GUI of the digital audio control surface may be designed for use with a traditional personal computer (“PC”) system where the software-based controls are manipulated through use of a mouse as the input. Alternatively, more recent digital audio control surfaces have been integrated into devices having touch-sensitive screens or displays, such as tablet computers (e.g., the Apple iPad, an Android-based tablet, etc.). Here, a touch-enabled computer display tablet connected to a DAW can provide software control via touch input. Alternatively, computer tablet devices with computer processing capabilities equipped with touch screens running DAW applications may similarly provide DAW functionality and parameter control via touch inputs. Still other devices known in the art may include digital audio mixing tools that perform as a sub-feature of other music production software, both computer-based and dedicated hardware-based. For example, some music production devices like hardware sampler workstations may incorporate digital recording and mixing tools. In essence, the control surface interface and virtual controllers can process information as a DAW or interact with the hardware controllers of the DAW processing unit to alter the audio quality parameters.

The problem is that the above-mentioned digital devices known in the art all include drawbacks that prevent them from functioning on a comparable level as traditional analog production consoles that use hardware controls such as knobs, buttons, sliders or faders. This is one reason that some sectors of the audio production industry has been slow to change over from analog to digital. For instance, analog mixing consoles provide a simple service to audio professionals; i.e., turn a knob, push a button or move a slider/fader to execute a desired function. Analog consoles are also able to control multiple audio sources and related audio parameters simultaneously. Some digital input devices such as PCs, tablets and touch sensitive monitors are capable of multi-touch operation, which allows one to control more than one parameter at a time. But, Mac OS and DAWs running on Mac OS do not currently support multi-touch. These devices are limited to single input, such as by a mouse cursor or one finger touch input. Further to this point is the fact that tablets are too small to enable a comprehensive multi-touch environment in a typical audio production setting anyway. So, even with the digital revolution, audio professionals often demand analog-based systems that use a cherished, however aged, workflow standard.

The problem now is that the most beloved traditional analog “one knob, one function” interfaces simply cannot provide the comprehensive, start-to-finish variable parameter control that modern DAW-based systems allow. In this respect, software can change and the GUI can adapt, but the traditional mechanically operated analog production consoles cannot. The physical make-up of the analog console inherently constrains its functionality and limits its adaptability compared to modern digital software tools. Trying to replicate or represent all the controls available within a DAW software application in an analog console is not practical for reasons related to expense of the electronics and size limitations associated with being able to operate such a large console (even if all the parameters could be replicated).

One of the main drawbacks of software and computer-based recording and mixing systems (DAWs), despite having the advantage of near-limitless control parameters, is the standard means for controlling parameters displayed on the computer screen with intermediary control input devices, such as a mouse, keyboard, or trackball. These devices inhibit direct control over the functionality of any given parameter. In this respect, the input device itself is generic to the control of each individual parameter. The pointer, for example in mouse or trackball examples, must navigate to the desired on-screen parameter control, thereafter “clicking” to change the effect. Contrast such a system with the traditional analog production console that includes one or more physical or mechanical controls uniquely assigned to a parameter. A common generic pointer is not used to change the control, but rather direct physical manipulation of the actual physical control itself. In this respect, adaptable, programmable digital “keys” can sometimes be confusing and less intuitive compared with direct, 1:1 controls present in traditional analog workstations. The problem with the analog device is that the physical control surfaces (i.e., knobs, buttons, faders, etc.) cannot be assigned and reassigned to control various software parameters; and cannot be altered in physical form. Digital console software can be updated and expanded, and designed to mimic these physical knobs, buttons, faders, etc. on-screen, but current proprietary/closed-source software architecture inhibits full software and hardware integration to maximize the benefits of a DAW over an analog production console.

The success of implementing single and multi-touch displays to control DAW software depends on the characteristics of the touch recognition hardware and the capabilities of the operating system of the connected computer. One of the most prevalent computer operating systems is Mac OS, by Apple Computer. Mac OS is not inherently multi-touch display enabled. Connecting a conventional touch screen to a computer running Mac OS provides single touch input control corresponding to and limited to the functionality of the mouse input device. Windows 7 OS is multi-touch enabled, recognizing multiple touch inputs and some touch gestures for control of GUIs and as a single touch input control corresponding to and limited to the functionality of the mouse or trackpad input device. At this time, DAW software has not been developed to take advantage of multi-touch display tactile control. Simply plugging a multi-touch display into a computer does not automatically make it an advantageous workflow experience.

The limitations of touch sensitive DAW integrated devices, such as tablets, are closely associated with small size and limited processing power and speed for executing DAW tasks. The relatively small touch-screen display (e.g., typically around 7-10″ diagonal) limits the size of the GUI and the amount of information available for control at one time. Compare the size of this virtual “console” with traditional analog consoles that can span a dozen or more feet on the diagonal. In this respect, the analog consoles are far larger than a tablet screen. These size limitations are certainly adverse in an audio production environment. Here, it is often important to know how one part or parameter relates to another part or parameter. As such, the operator must be able to see all the parameters and elements at once. On one hand, a tablet that does not show all these parameters and/or elements has limited use because there are not enough parameter/element options to adequately simulate the tablet as a DAW. On the other hand, a tablet that does show all available parameters and/or elements compromise adequately sized controls in favor of fitting more controls on the display—this is certainly not an adequate long-term solution as it would become next to impossible to accurately select and operate a control. Naturally, the size of GUI control is a primary concern in a tactile control environment. Furthermore, tablets are limited in the number of applications and types of DAW software compared with a standard PC, be it a Mac or Windows OS.

More specifically with respect to products currently on the market, the iPad, manufactured by Apple Inc. of 1 Infinite Loop, Cupertino, Calif. 95014, can serve as a multi-touch DAW controller. But, the shape and small size of the iPad (9.7″ diagonal) cannot provide the type of design appearance or workflow layout comparable to any large analog recording console. Similarly, the Red Leaf TS Control-32 is similarly handcuffed by a small work surface compared to large-format analog consoles. While the TS Control-32 includes a touch-sensitive screen, it has limited input capabilities because it can only process one input at a time. This means that a user cannot control more than one parameter simultaneously through a multi-touch interface. The TS Control-32 also lacks analog or digital audio inputs, outputs, routing or monitoring; and it does not incorporate physical knobs or buttons, a keyboard or a trackball. The TS Control-32 uses an older, slower and less accurate means of touch detection called Surface Acoustic Wave, or SAW.

Another product called the Tango, manufactured by Smart AV Pty Ltd. of 19 Hutchinson St., St Peters, NSW 2044, Sydney, Australia, is another DAW controller known in the art, but this controller does not allow direct, on-screen touch control of the DAW GUI. Additionally, the Tango fails to include analog or digital audio input, output, routing or monitoring features. It further does not incorporate a physical computer keyboard and includes an insufficiently small display. Particularly problematic is that the Tango is not meant to display a custom DAW with its own built-in display and is, therefore, not meant to control a DAW GUI directly. Another product called the Smithson Martin Emulator made by Smithson Martin Inc. of 2283 Argentia Rd. Unit #22, Mississauga, Ontario L5N 5Z2 Canada, provides no analog or digital audio inputs, outputs, routing or monitoring and does not incorporate a physical computer keyboard or attempt direct control of existing DAW software. In this respect, the Smithson Martin Emulator is intended for use by DJs and has no physical controls beyond a touch-display. The display image of the Emulator is generated by a noisy rear-projector and can limit the placement geometry options for the controller. In this respect, the form factor is very different when compared to traditional analog consoles.

Thus, there is a need in the art for an audio production console that solves the above-mentioned deficiencies by utilizing elements of a traditional analog mixing console in a DAW controller environment. Such an audio production console should include a multi-touch computer display, an audio monitoring controller, incorporation of a physical workflow and familiar ergonomics of a large analog mixing console with the flexible and expandable functionality of a DAW controller in the form of a multi-touch computer display that has the speed, reliability, and familiarity of an analog audio monitoring controller. The present invention fulfills these needs and provides further related advantages.

### SUMMARY OF THE INVENTION

The audio production console disclosed herein includes a DAW controller, a multi-touch computer display, and an audio monitor controller provided in a single console device reminiscent of an analog console in terms of look, intuitive operation, and familiar ergonomics. In this respect, the audio production console replicates a physical workflow in a digital graphical workflow environment of a DAW by providing direct tactile control of virtual software parameters on a multi-touch input large-format display. The large physical control surface replicates the size, positioning and placement of audio parameter controls comparable to the size, positioning and placement of such controls in an analog production console. This allows for direct user control of these control parameters through a GUI capable of processing multi-touch on-screen input to replicate and expand upon the form and feel of a traditional analog production console.

From a general perspective, the audio production console disclosed herein functions as a DAW controller, yet replicates the appearance, form factor and interface functionality of large analog consoles. Like an analog console, the audio production console is a tactile controller, but one that converts virtual computer controls into tactile controls. Furthermore, the console includes software that is adaptable to specific control parameters and limited only by the broad possibilities of the software and GUI interface. In this respect, the control boundaries are virtually boundless. The limitless nature of software and the GUI is one of the primary advantages of modern DAW-based production consoles. In this respect, the virtual parameters displayed on the computer screen by the DAW software are meant to provide virtual control over the otherwise physical controls. The software further permits the knobs, buttons, faders/sliders, etc. to be assigned and reassigned to control various audio manipulation parameters.

Furthermore, the audio production console disclosed herein uses a tactile touch sensing interface system and GUI to control DAW functions. Traditional hardware audio control surfaces are designed to perform different functions; therefore, these surfaces vary widely in size, shape and number and type of controls. It is now possible to combine all these traditional hardware audio control surfaces into one unit as the surface itself is governed by the display of the control parameters, which are not inherently hardwired to certain controls. In other words, since the GUI is software-based, it is inherently adaptable and can be designed to present various workstations depending on the project or preference of the user.

More specifically, in a preferred embodiment, the audio production console may include a chassis that supports a monitor for displaying an interactive graphical user interface having at least two on-screen audio controls. In one embodiment, these on-screen audio controls may include a knob, fader, button or a hot key. The hot key may simultaneously adjust multiple audio control parameters at once. The monitor may include a nanotechnology glass coating having a thickness less than or equal to two (2) millimeters and is preferably an LCD display having an at least 46 inch diagonal screen held by the chassis at an angle between 30 and 40 degrees. Furthermore, the chassis may include a meter bridge for displaying analog or digital Volume Unit (“VU”) meters and/or LED meters and may include a console panel extending out therefrom and generally positioned horizontally to support an input device.

The audio production console also preferably includes a multi-touch sensing system supported by the chassis, such as an infrared multi-touch sensing system or a capacitive-based multi-touch sensing system. In a preferred embodiment, the infrared multi-touch sensing system includes a plurality of infrared light emitters and a respective plurality of infrared light detectors disposed around a periphery of the monitor. The infrared light emitters generate a plurality of infrared light beams for reception by the light detectors. In essence, these infrared light beams form a grid over the surface of the monitor and permit the sensing system to simultaneously locate and track at least two input events respectively corresponding with at least two of the on-screen audio controls displayed by the interactive graphical user interface.

Furthermore, an audio controller may associate the input events located and tracked by the multi-touch sensing system with respective audio control parameters represented graphically as the on-screen audio controls by the interactive graphical user interface. A feedback controller then adjusts an audio track in response to changes to the audio control parameters linked to movement of the on-screen audio controls as part of the input events located and tracked by the multi-touch sensing system.

In a related audio production process, an interactive graphical user interface having at least two on-screen audio controls is displayed on a monitor in a manner replicating traditional analog audio controls in a digital two-dimensional environment. At least two input events are simultaneously located and tracked across the surface of the monitor by a sensing system. Preferably, the input events respectively correspond with the on-screen audio controls displayed by the interactive graphical user interface of the monitor. These located and tracked input events are associated with respective audio control parameters such that an audio track is adjusted in response to changes to the audio control parameters reflective of movement of the on-screen audio controls as part of the located and tracked input events.

The audio production console preferably simultaneously measures movement of the input events over the monitor and changes the respective audio control parameters relative to the measurements. In this respect, the console may further synchronize movement of the on-screen audio controls to the changes in the audio control parameters on a one-to-one basis. The audio production process may further include the ability for assigning an on-screen audio control to a different audio control parameter, generating a grid of interruptible infrared light beams over a surface of the display for purposes of locating and tracking movement of the input events, or relocating a panel carrying a plurality of the on-screen audio controls from one location on the display, to another location.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view showing the front, top and left sides of an audio production console as disclosed herein;

FIG. 2 is a perspective view similar to FIG. 1, further illustrating an a sensor grid disposed above a display screen;

FIG. 3 is an enlarged sectional view taken about the circle 3 in FIG. 2, more specifically illustrating a plurality of sensor beams extending across the surface of the display screen;

FIG. 4 is a top plan view of the display screen, illustrating the graphical user interface displaying multiple panels having a plurality of audio controls;

FIG. 5 is a top plan view similar to FIG. 4, illustrating a user dragging a first panel having a first set of on-screen controls to a new position;

FIG. 6 is an alternate top plan view similar to FIGS. 4 and 5, illustrating the user dragging a second panel having a second set of on-screen controls to a new position;

FIG. 7 is an alternate top plan view similar to FIGS. 4-6, illustrating the user holding the first panel in detached relation relative to the other control panels displayed through the graphical user interface;

FIG. 8 is a top plan view similar to FIGS. 4-7, illustrating the user manipulating the on-screen controls displayed on the graphical user interface;

FIG. 9 is an enlarged sectional view taken about the circle 9 in FIG. 8, further illustrating user manipulation of on-screen controls such as faders, knobs and/or buttons;

FIG. 10 is an alternate enlarged sectional view similar to FIG. 9, further illustrating simultaneously manipulating three faders downwardly as displayed on the graphical user interface;

FIG. 11 is a perspective view of the sensor grid overlying the graphical user interface display screen, and illustrating user control manipulation;

FIG. 12 is a cross-sectional view taken about the line 12-12 in FIG. 11, illustrating interruption in the sensor grid of intersecting beams, which allows user manipulation of audio controls by way of the graphical user interface;

FIG. 13 is a perspective view similar to FIGS. 1-2, illustrating an auxiliary tray carrying an external computer that couples to the audio mixing console.

### DETAILED DESCRIPTION OF THE PREFERRED EMBODIMENT

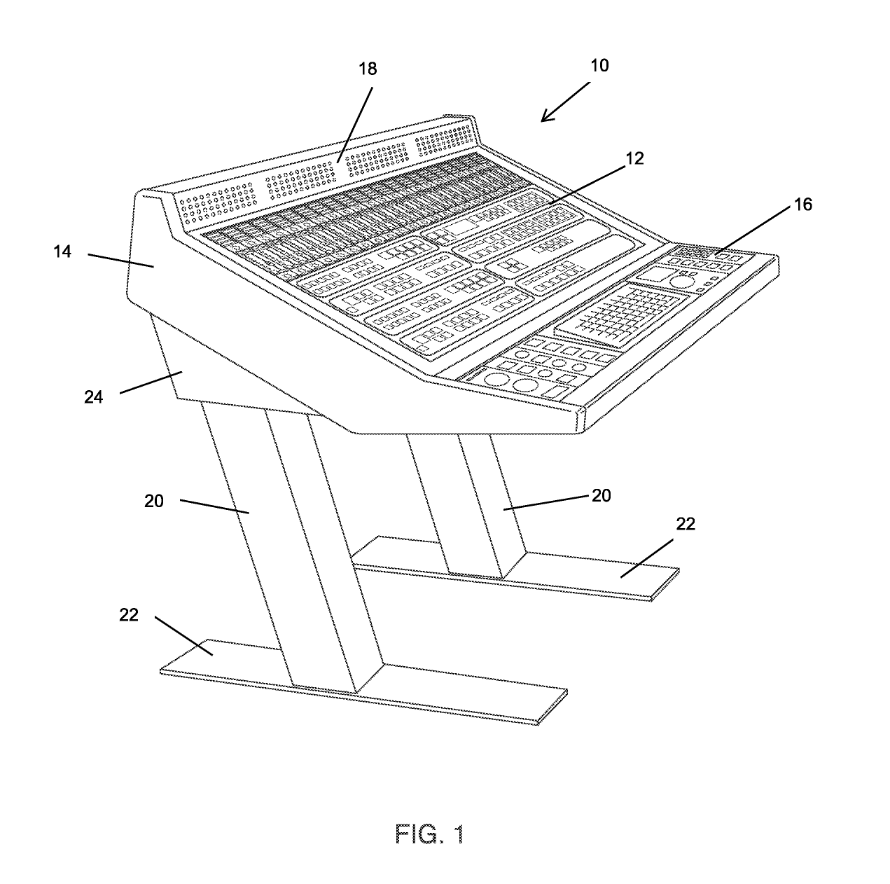

As shown in the exemplary drawings for purposes of illustration, the present disclosure for an audio production console is referred to generally by the reference numeral 10 in FIGS. 1-8 and 13. The audio production console 10 is versatile and may be used in a number of different recreational or professional environments, including recording, mixing, mastering, music composition, and production applications. The traditional analog recording console provides control over a variety of parameters such as audio levels, timbre, stereo placement, and dynamics of multiple sound sources for the purpose of recording those signals and/or combining them into formats better suited for distribution to listeners. Such consoles, and in particular the audio production console embodiments disclosed herein, are essential tools for music and audio production and sound reinforcement.

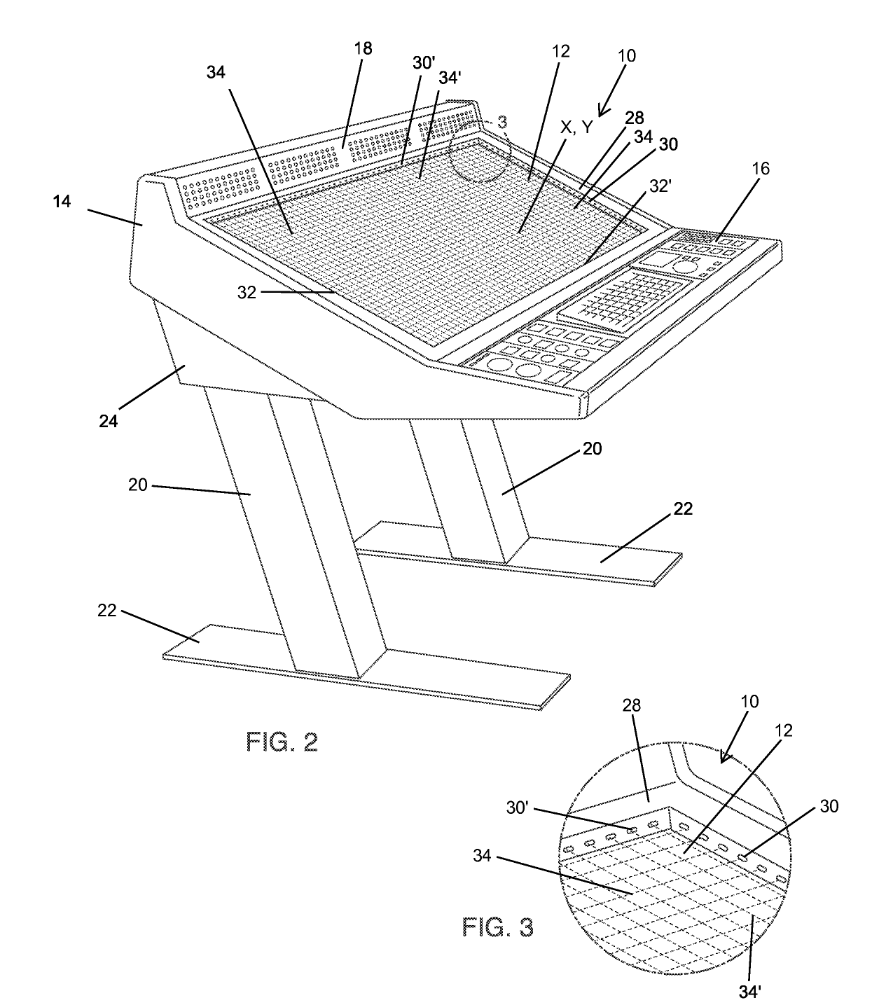

In general, the audio production console 10 shown in FIGS. 1, 2, and 13 includes a large format computer display or monitor 12 built into or cradled by a chassis 14 that includes a generally horizontal console panel or workplace 16 and a meter bridge 18. In one embodiment, the display 12 includes a capacitive touch-sensitive surface responsive to hand, finger, or stylus contact or other means for triggering the capacitive sensor to operate certain aspects of the operating software. Preferably, this touch sensitive surface includes the capability of identifying, receiving and processing multiple-touch inputs simultaneously. In another embodiment discussed in greater detail below with respect to FIGS. 2, 3, 11 and 12, the display 12 may utilize a light or infrared sensor that beams light across the surface of an LCD or substantially flat screen display. In this respect, such an infrared touch screen may use an array of (X, Y) coordinate infrared LED and photo detector pairs around the screen edges (e.g., as shown specifically in FIG. 3) to detect disruption in LED beam patterns to pinpoint touch locations. One benefit of infrared sensors is that they can detect virtually any input that disrupts the LED beam patterns and do not otherwise require patterning on glass, which can decrease durability and optical clarity of the overall system. Additionally, the display 12 disclosed herein may employ the use of a nanotechnology glass coating applied to a thin (e.g., 2 mm) protective glass to improve the feel, finger glide, light transmission, and to reduce the undesirable parallax commonly associated with infrared touch interfaces. The prior art devices mentioned above are particularly problematic in that they only support a single-input interface wherein a user cannot operate more than one parameter at a time. In this respect, the multi-touch display 12 is advantageous over these prior art devices.

FIGS. 1-13 further illustrate the general features of the display 12, the chassis 14, the console panel 16 and the meter bridge 18. In this respect, FIG. 1 is a perspective view illustrating the audio production console 10 having the chassis 14 generally supported in an elevated position by a pair of upstanding supports 20. The supports 20 may angle backwardly as generally shown in FIGS. 1, 2 and 13 to provide added room underneath the chassis 14 (including the display 12 and the console panel 16) for slide-in reception of a chair. In this respect, a user is able to slide up underneath the chassis 14 to be intimately close to the console panel 16 and more importantly within room to comfortably touch or operate all aspects of the display 12. Although, a person of ordinary skill in the art will readily recognize that other possible configurations will be compatible with the layout of the display 12 (e.g., straight or inwardly angled supports 20, or a substantially horizontal or vertical display 12) such that the user is able to comfortably touch and interact with all aspects of the display 12. The supports 20 rest on a pair of feet 22 that extend horizontally across a floor or surface upon which the audio production console 10 sits.

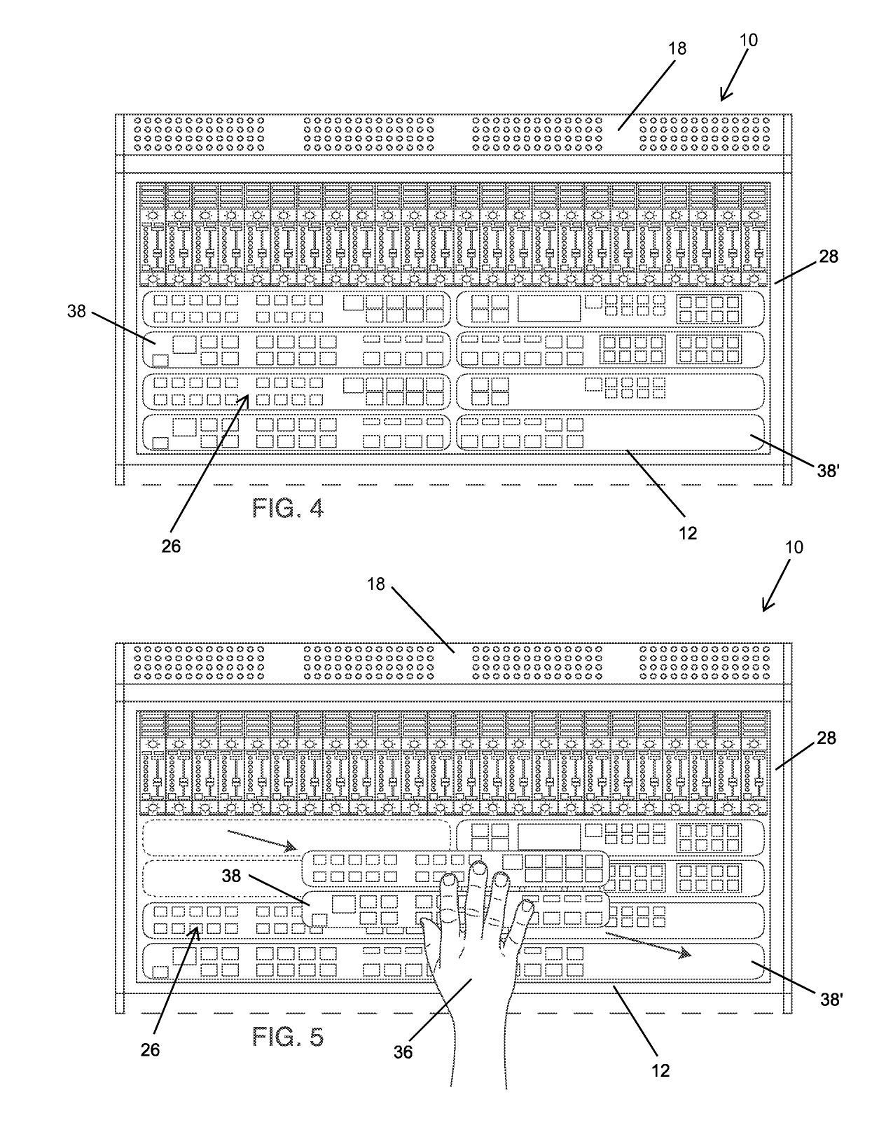

The preferred aesthetic angular construction of the audio production console 10 is generally shown in the perspective views of FIGS. 1, 2 and 13. The generally flat or horizontal feet 22 couple to one end of the supports 20 that extend up underneath and couple to the chassis 14 at the other end. An electronics panel or housing 24 may be disposed behind the display 12 and be formed out of a portion of the chassis 14. This housing 24 may include various electronics, circuitry, controllers, etc. that operate the display 12 or process changes to the sound effects parameters, such as audio levels, to provide clear and flexible monitoring of audio sources such as the DAW or external sources. Such circuitry could include analog and/or digital audio circuitry. The display 12 preferably sits at a somewhat sloped angle, e.g., between 30° and 40° or the like, and is angled relative to the meter bridge 18 and the console panel 16 to allow a user to comfortably hand-operate an on-screen graphical user interface (“GUI”) 26 (shown in FIGS. 4-10 and discussed in more detail below) as one may otherwise operate a traditional analog production console with knobs, buttons or other mechanically operated controls. Preferably, the display 12 is a touch-sensitive surface that is at least 46-inches, measured diagonally, with a pixel resolution of at least 1920 pixels by 1080 pixels. Although, a person of ordinary skill in the art will recognize that the display 12 may vary in size and/or resolution as long as the display 12 can be adequately operated as disclosed herein.

As illustrated in FIGS. 2 and 3, the display 12 preferably includes an infrared-based (“IR”) sensor frame 28 that translates detected inputs into touch events. One particularly advantageous aspect is that the IR sensor frame 28 is able to process more than one touch input simultaneously. The IR sensor frame 28 surrounds the perimeter of the display 12, sitting just above the surface of the display 12, to detect touch input from a finger or other pointing device (e.g., a stylus) that physically interrupts transmission of IR beams from one side of the IR sensor frame 28 to the other. Touch events are mapped to an (X, Y) coordinate system and are transmitted to a computer to update what the display 12 shows on the GUI 26 as control data.

More specifically, as shown in FIGS. 2 and 3, the audio production console 10 includes a plurality of infrared light emitting diodes (“LEDs”) 30 that correspond with a plurality of photo or light detectors 32 positioned around the periphery of the display 12, and preferably integrated into the IR sensor frame 28. The individual LEDs 30 may all be positioned on one side of the frame 28 (e.g., on the top and right sides) and the corresponding detectors 32 may all be positioned on an opposite side of the frame 28 (e.g., on the bottom and left sides). Alternatively, one or more of the LEDs 30 and the detectors 32 may integrated into a common side of the frame 28 (e.g., alternating between the LED 30 and the detector 32) as long as there is a corresponding detector 32 or LED 30 respectively integrated into the opposite side of the frame 28. As an example, FIG. 2 illustrates a first pair of the LEDs and detectors as numerals 30 and 32, respectively. As shown, the LED 30 is integrated into the right side of the frame 28 and emits a horizontal infrared beam 34 across the surface of the display 12 toward the left side of the frame 28. As indicated in FIG. 2, a corresponding detector 32 is integrated into the left side of the frame 28 and in substantial alignment with the LED 30 for reception of the beam 34. Similarly, FIG. 2 illustrates a second pair of the LEDs and detectors, respectively identified as numerals 30′ and 32′. Here, the LED 30′ is integrated into the top side of the frame 28 and emits a vertical infrared beam 34′ across the surface of the display 12 toward the bottom side of the frame 28. As indicated in FIG. 2, the corresponding detector 32′ is integrated into the bottom side of the frame 28 and in substantial alignment with the LED 30′ for reception of the beam 34′. The intersection of the beam 34 with the beam 34′ is identified by the coordinate (X, Y). Thus, the plurality of the LEDs 30 disposed around the exterior of the frame 28 creates a plurality of the beams 34 that form a grid across the surface of the display 12, for reception by a corresponding or respective detector 32. Of course, the intersection of these beams 34 creates a plurality of (X, Y) intersection points or coordinates over the display 12. The plurality of the LEDs 30 and the detectors 32 are preferably coupled to a computer system (not shown) that may be integrated into the chassis 14 of the console 10 (or externally attached) for tracking interruption of one or more of the beams 34 and for determining the interruption (X, Y) coordinate, during the course of operating the console 10. The computer may be a separate or external computer system (e.g., a connected iPad, desktop, or laptop computer system) coupled to the console 10 or the display 12 via a USB connection or other similar data transmission interface.

The computer system is designed to track interruption of the beams 34 across the surface of the display 12 to identify a “touch” point. For example, when a finger or stylus touches the display 12 at the (X, Y) coordinate shown in FIG. 2, transmission of the horizontal beam 34 and the vertical beam 34′ to detectors 32, 32′, respectively, is interrupted. That is, the finger or stylus blocks transmission of the beams 34, 34′ such that the detectors 32, 32′ no longer sense reception of the beams 34, 34′. Accordingly, the computer system is able to identify discrete (X, Y) coordinate “touch” points over the surface of the display 12. In fact, the system is able to identify multiple “touch” points simultaneously because the event is tied to a break in the transmission of intersecting horizontal and vertical infrared beams 34. Therefore, when a finger or stylus touches the display 12, the computer can determine the location of one or more interruptions over the surface of the display 12 based on which detectors 32 in the IR sensor frame 28 do not receive or sense the corresponding beam 34. Thus, because each horizontal beam intersects each corresponding vertical beam only once, and each vertical beam intersects each horizontal beam only once, the audio production console 10 can process multiple inputs simultaneously based on discrete or specific interruption points over the display 12.

Moreover, the computer system or software of the audio production console 10 can track the movement of the finger or stylus along the surface of the display 12 by tracking the movement of these discrete interruption points. That is, movement of a finger along the surface of the display 12 causes measurable changes in sensed interruption points on the surface of the display 12. For instance, as mentioned above, placement of a finger at the (X, Y) coordinate causes interruption of the beams 34, 34′ from one side of the frame 28 to the other, such that the corresponding detectors 32, 32′ no longer sense transmission. In turn, the computer system knows the discrete point, i.e., point (X, Y) where the finger is placed. But, sliding the finger vertically away from the (X, Y) coordinate toward the top of the frame 28 (i.e., toward the meter bridge 18) causes retransmission of the beam 34 to the detector 32 such that the computer system no longer identifies an interruption (i.e., “touch” point) at the (X, Y) coordinate. Instead, the touch point has now moved to coordinate (X+1, Y). In this example, the vertical beam 34′ is still interrupted, but the horizontal beam 34 is not (i.e., it is detected or sensed by the detector 32 because it is no longer blocked). Instead, the horizontal beam immediately above the beam 34 is now blocked, such that the computer system identifies the “touch” input at coordinate X+1, Y. Thus, as the position of the finger or stylus changes on the display 12, the detectors that fail to receive or sense an infrared beam will change to correspond with the change in position of the finger or stylus above the display 12. This feature is particularly advantageous for use with the audio production console 10 as it permits the computer system or software to track sliding movement of multiple touch inputs simultaneously so the user can simultaneously move or manipulate multiple knobs, buttons, sliders, faders, etc. as if manipulating multiple mechanical analog controls commonly integrated in known analog audio production consoles.

More specifically, touching the display 12 in multiple different places creates multiple breaks in the sensor grid. The computer or software can determine the location of each “touch” point on the display 12 in the same manner for determining a single “touch” point, as discussed above. Accordingly, the computer or software can track the movement of multiple “touch” points independently and simultaneously in the same manner that the movement of a single “touch” point was tracked, including sliding movement of multiple touch points across the surface of the display 12. The computer or software synchronizes movement of the “touch” points to movement of controls shown on the display 12. For example, if a slider button resides at the (X, Y) coordinate, one may move the slider by first creating a “touch” point at the (X, Y) coordinate, and then moving the “touch” point through sliding motion over the top of the display 12 to the (X+1, Y) coordinate, as described above. Accordingly, the computer or software would correspond this movement to movement of the fader button from coordinate (X, Y) to coordinate (X+1, Y), and such movement would be represented on the display 12 and the corresponding audio control would be changed accordingly. Thus, the audio production console 10 disclosed herein makes it possible to move multiple faders (or other controls) simultaneously through movement of a finger across the (preferably) invisible grid of beams 34 projecting over the top of the display 12.

The multi-touch control data is processed via a software protocol called TUIO, which is an open framework that defines a common protocol and application programming interface for tangible multi-touch surfaces. The TUIO protocol allows the transmission of an abstract description of interactive surfaces, including touch events and tangible object states. This protocol encodes control data from a tracker application (e.g., the IR sensor frame 28) and sends it to any client application that is capable of decoding the protocol—in this case circuitry that manipulates audio. As such, through the use of the TUIO protocol, the display 12 is able to track simultaneous input events as if the display 12 were operating as a multi-touch interface. In this respect, the console 10 includes a mixer capable of decoding and routing multi-touch information to the various audio controls. That is, the integrated mixer is able to translate a decoded “touch” event, or multiple simultaneous “touch” events, into information that may be used to process an audio parameter adjustment, such as converting control information to MIDI information for use with software running on a connected computer, as described in more detail below.

As illustrated in FIG. 4, the structure and operation of the audio production console 10 is designed to physically replicate traditional analog audio production consoles, but with greater functionality through the implementation of digital technology. That is, the physical design of the console 10 replicates the desired ergonomics reminiscent of classic analog recording consoles, such as the Solid State Logic 4000 Series, Neve 80 Series, Trident A-Range and API Legacy, among other large-format analog recording and mixing consoles. In this respect, the display 12 is preferably able to manifest this desired analog recording console environment with the GUI 26. More specifically, the console 10 advantageously integrates the intuitiveness of a direct touch device with a digital multi-touch display 12. Of importance to this design is the use of a software and computer based recording and mixing system (i.e., the Digital Audio Workstation, or DAW) that has the advantage of near-limitless control parameters. The software itself, when combined with a multi-touch display 12, is not limited to a single intermediary input device such as a mouse, keyboard, or trackball. Instead, the layout of the GUI 26 permits simultaneous direct control (similar to traditional analog consoles) over audio parameters. The type and number of audio parameters are limited only by the software and the “surface area” (i.e., screen size) of the display 12. The display 12 preferably replicates the parameter controls in the form of knobs, buttons and faders/sliders, for example, in this virtual DAW environment. As discussed in greater detail below, the knobs, buttons and faders/sliders operate in this digital or virtual environment similar to physical controls. Preferably, the console 10 provides software for converting virtually all the physical controls associated with traditional audio production stations into the digital touch-screen interface described herein. Although, the console 10 may include some physical controls to retain familiarity/association with classic analog design. In this embodiment, the functionality of the physical controls may be segregated from the processing that occurs in the DAW. For example, the physical controls may only monitor audio levels.

More specifically with respect to the control interface, the console 10 includes the ability to directly control the display of parameter controls through a Digital Audio Workstation (“DAW”) controller that directly interacts with the TUIO software protocol. In this respect, the display 12 operates as a DAW to digitally emulate many of the functions of a classic analog recording console, including, but not limited to, level control, signal routing and combining, editing, composing, equalization and dynamics control. The GUI 26 represents the parameters of a mixing console. That is, the GUI 26 digitally recreates analog controls such as faders, knobs, and buttons typically found in an analog recording console on the display 12. The parameters on an analog mixing console are changed by directly touching the controls, whereas the mixing controls within a DAW are typically controlled via intermediary devices like keyboard, mouse, trackball, or some other hardware controller. The console 10 controls DAW parameters through direct touch of those parameters on the multi-touch computer display 12.

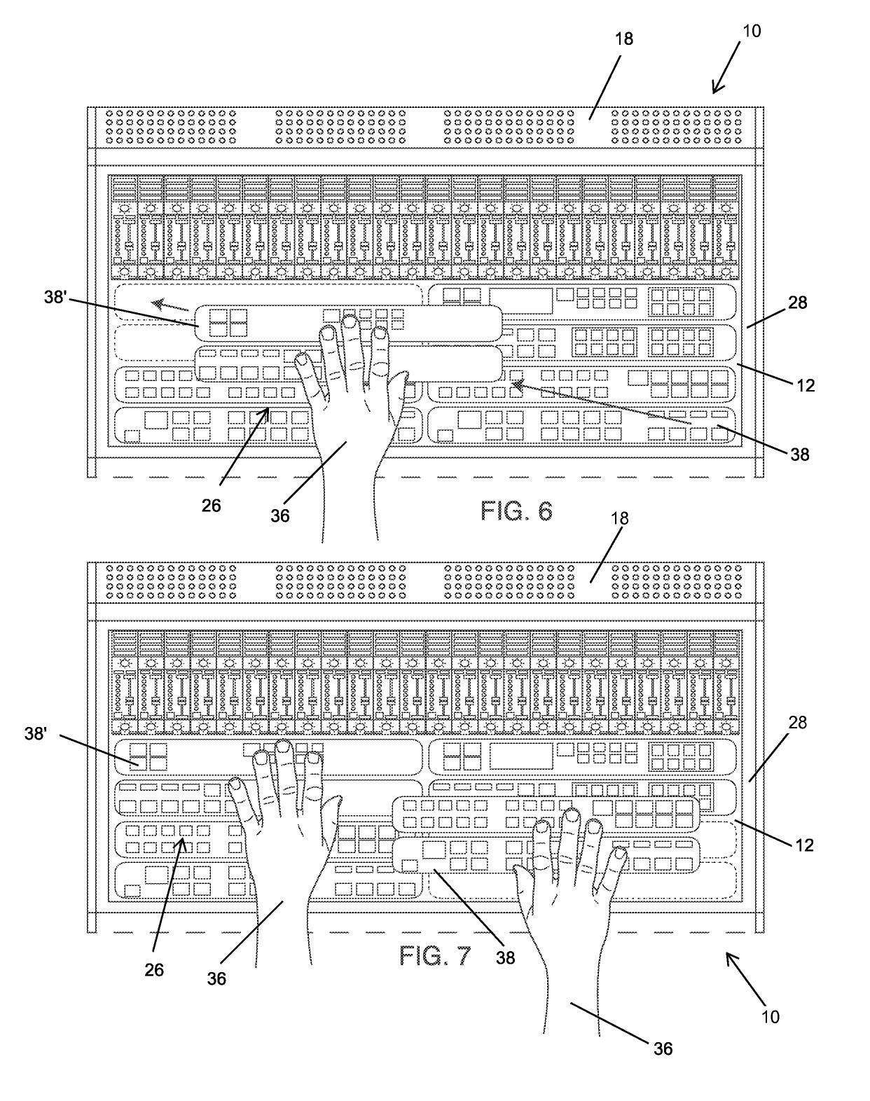

One particular advantage to the console 10 is that the software permits the controls to be assigned and/or reassigned, depending on the needs of a particular user. For example, FIGS. 4-7 illustrate a hand 36 manipulating placement of a digital panel 38 from one position to another, as shown on the display 12. Here, the hand 36 is shown dragging the digital panel 38 from the upper left-hand position shown in FIG. 4, and over several other panels (FIG. 5) for eventual placement in the lower right-hand corner as shown in FIG. 6. Similarly, the hand 36 is shown picking up a second digital panel 38′ from the lower right-hand corner (as shown in FIG. 4), and over several other panels (FIG. 6) for eventual placement in the upper left-hand corner as shown in FIG. 7. This feature permits the user to optimize the layout of the GUI 26 by placing related panels and controls into the same area of the display 12. Moreover, different audio mixing tasks may require using different controls. Therefore, the user can modify the arrangement of controls based on the specific requirement of the task at hand, thereby reducing the need for a “one size fits all” approach to the control layout as is required in analog consoles. The GUI 26 further allows the user to activate and deactivate specific controls (e.g., faders, knobs, etc.) on each panel. Since certain tasks may not require every control, the user can deactivate the controls not needed to prevent inadvertent manipulation of the control. When a task requires adjustment of a deactivated control, the user can simply reactivate the control. Reassignment in this manner allows the controls to be readily changed in the event a different layout is desired. As a result, the console 10 is not limited to the hardwiring, as were traditional analog consoles. Instead, the physical form of the console 10 stays the same, while the GUI 26 may change to desirably mimic the parameter controls on the display 12. In essence, the control surface (i.e., the display 12) can adapt as infinitely as the software. In this respect, the console 10 obtains a level of customization not previously attainable by any other console known in the art.

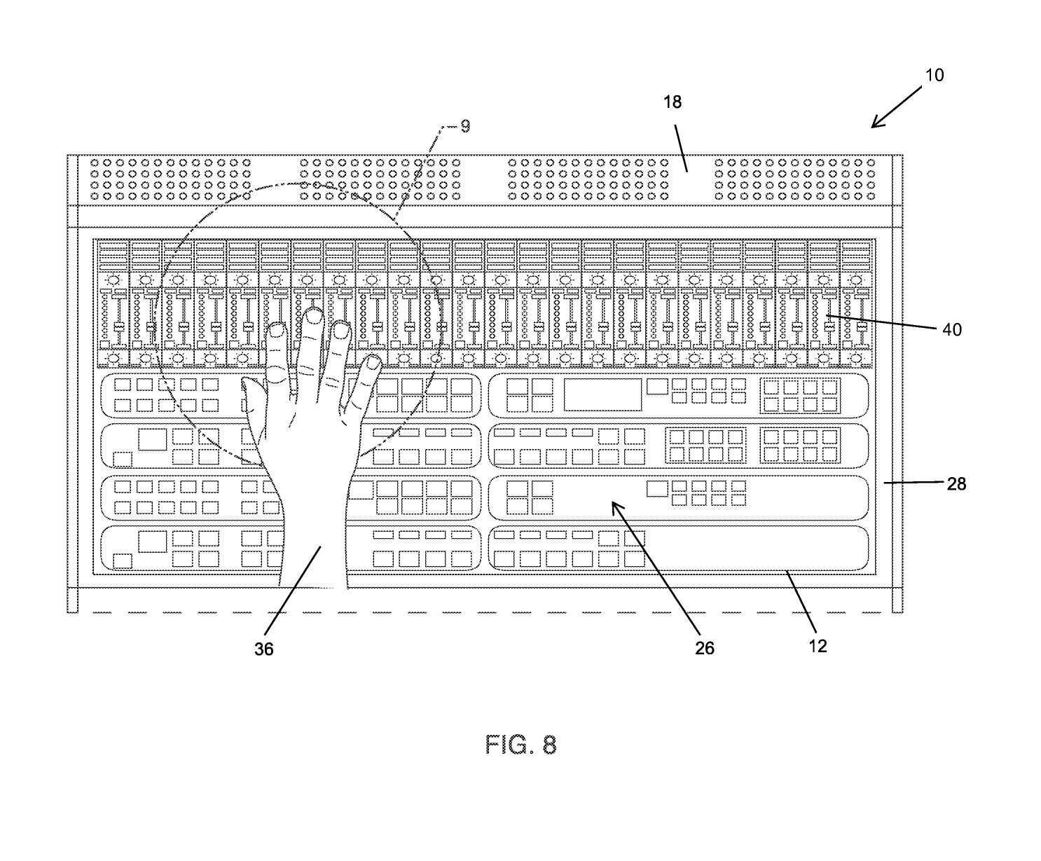

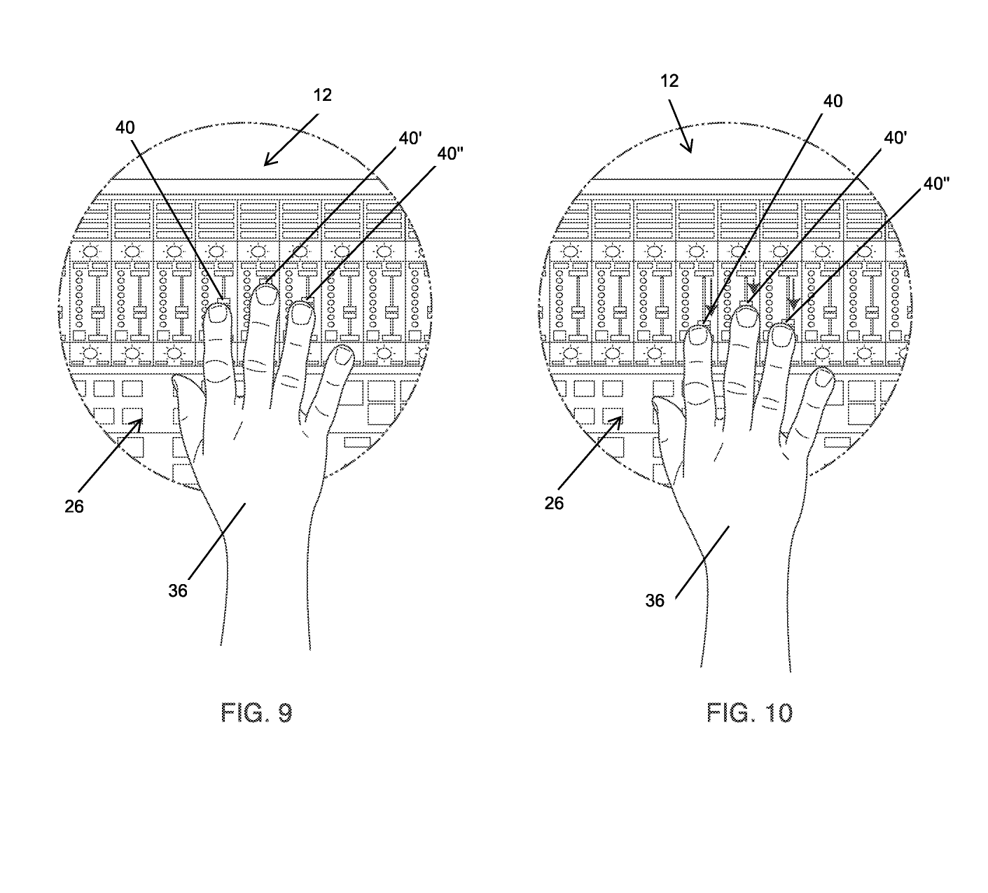

As illustrated in FIGS. 8-12, the display 12 of the console 10 is unique among DAW controllers because the mixing controls are touched and affected directly by the user's fingers on the touch screen display 12, with no intermediary device (e.g., a mouse or keyboard). This way, audio mixing processes via the console 10 are like those on an analog mixing console. For example, one primary DAW control parameter is called a “fader”. The fundamental nature of level adjustment to the operation of audio signal processing equipment is described in detail in relation to the Solid State Logic device disclosed in detail in U.S. Pat. No. 5,268,964 to Watts, the contents of which are herein incorporated by reference in its entirety. A fader is basically a slider used to adjust the overall volume of audio signals within the DAW. Faders are typically found on a subset of controls within a DAW called tracks, channels, buses, auxiliary sends, master fader, etc. As illustrated in FIG. 8, the display 12 may present a set of faders 40 across the full width of the 46-inch display 12 that the user may manipulate simply by touching the display 12. Analog consoles are known for having 100 mm length faders. To provide a familiar and similar functional ergonomic experience, the console 10 may replicate these 100 mm faders on the display 10 as similarly sized at 100 mm. Thus, as illustrated in FIGS. 9-10, a user may move or “slide” three of these faders 40, 40′, 40″ downwardly to simultaneously adjust multiple audio parameters. Preferably, users will find that that the positioning of the faders 40, 40′, 40″ and other controls are relatively comparatively spaced out in relation to traditional analog consoles. The touch-sensitive interface tracks the sliding movement across the surface of the display 12 to change the parameter settings (e.g., increasing the parameter or decreasing the parameter, as desired). The multi-touch aspect of the display 12, as described above, allows the user to move multiple parameters (e.g., sliding multiple “faders”) simultaneously. The same may be accomplished for other controls such as knobs, buttons, switches, etc.

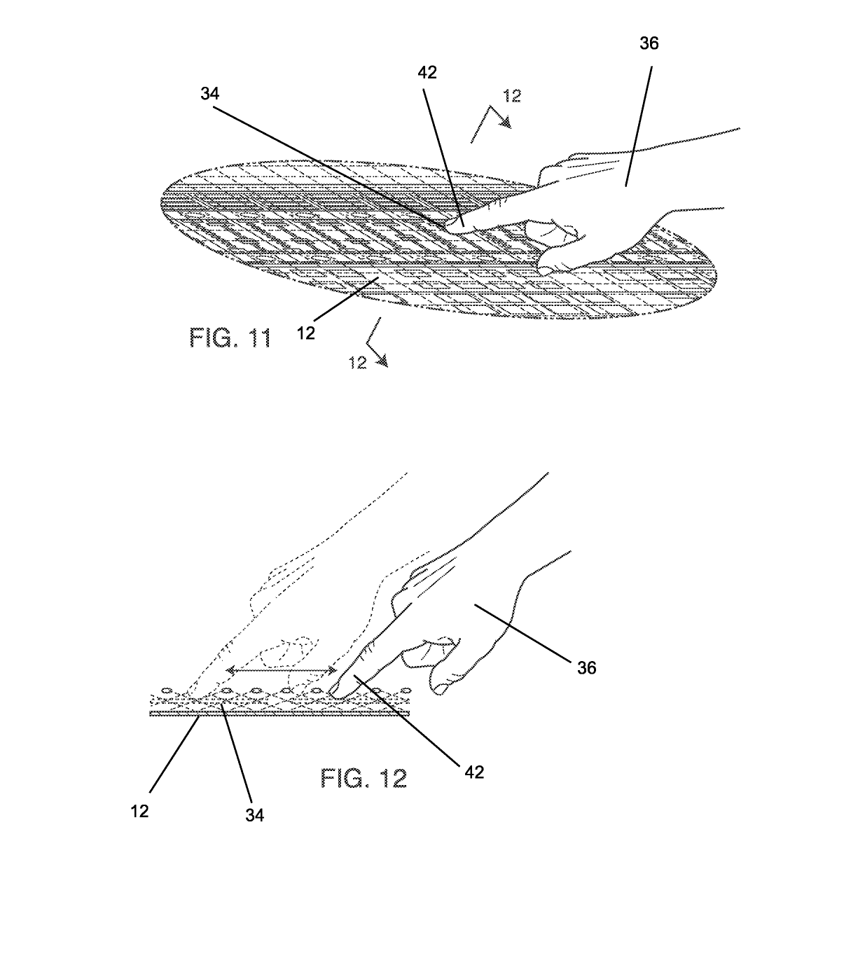

As discussed above, a grid of the infrared beams 34 is disposed just above the surface of display 12. In this respect, FIGS. 11 and 12 more specifically illustrate interruption of at least one infrared beam 34 in the grid when touching the display 12 with a finger 42. This disruption prevents the corresponding detector 32 disposed in the frame 28 from receiving or sensing the corresponding beam 34. The computer or software then correlates the particular detector(s) 32 not receiving or sensing the beam(s) 34 to a specific position on the display 12, as discussed above, corresponding to a particular control operated by the console 10. The computer or software then adjusts the control on the GUI 26 to track movement of the finger 42 over the surface of the display 12.

In this respect, FIG. 12 more specifically illustrates movement of the finger 42 over the surface of the display 12, wherein the finger 42 breaks or interrupts transmissions of several of the beams 34 along the way. This concept may similarly be extrapolated for multi-touch input, such as shown in FIGS. 8-10. After the finger 42 passes by one beam, the respective detector again receives or senses the beam (i.e., the beam reforms since the finger is no longer an obstruction). The computer or software can determine how the user intends to manipulate one or more of the audio controls integrated into the console 10 based on the order the beams 34 are broken and reformed. For example, the computer or software can determine the distance the user intended to adjust a control (e.g., a fader) based on the number of beams that are broken and reformed. That is, the more intersections that break and reform, the farther the user adjusted the control. In this respect, in one embodiment, the beams may be at specific distances from one another (e.g., 20 millimeters) such that the computer or software will visually represent the movement of a fader 40, for example, approximately 20 millimeters on the display 12 when one beam breaks and the preceding beam reforms. Of course, these distances may be larger or smaller, depending on the desired tolerances. The computer or software can also determine how the user intends to adjust a particular control (e.g., increasing or decreasing a parameter) by sensing the order the intersections break and reform. That is, the computer can determine that a user intends to decrease a parameter control (e.g., a fader) if the beam intersections break and reform sequentially starting from the top of the console 10 and proceed downwardly toward the bottom of the console 10 (e.g., as shown in FIGS. 9 and 10). Similarly, if the beam intersections break and reform in the opposite sequence (e.g., from the bottom of the console 10 toward the top of the console 10), the computer or software determines that the user intends to adjustably increase the fader parameter control. Similar determinations can be made for knobs (e.g., circular motion) and other controls. Therefore, the computer or software can determine the type of control parameter the user endeavors to adjust, how far the user adjusts the control parameter, the direction the user endeavors to adjust the parameter, and the final value of the control parameter after adjustment. The computer or software not only displays the positional changes of the control or controls on the GUI 26, but also applies the changes to the sound recording, as would be accomplished through a mechanical control in a traditional analog workstation.

In this respect, once the computer or software determines how the user intends to adjust a particular control parameter, the software routes those instructions to the circuitry housed by the chassis 14 to be implemented with the hardware components coupled to the console 10. For example, as the user adjusts one or more parameters via the one or more touch inputs shown by the display 12, the computer or software determines how the user intends to adjust the control or controls and sends the corresponding signal or signals to the control circuitry, directing the circuitry to actuate various hardware components in a manner to achieve the desired audio changes in each parameter.

Furthermore, the DAW and customizable software allows the console 10 to produce “soft keys,” i.e., user-customizable GUI controls. For example, a single “soft key” can be programmed to initiate a series of multiple computer keyboard keystrokes with one touch. These “soft keys” can be introduced into a user customizable functional toolbar that provides a convenient and quick control center for parameters common to the DAW. Alternatively, the console software may also be programmed with “hot keys” designed to simplify multi-step tasks and improve efficiency of DAW operation. In this example, the “hot key” may activate a sequence of changes in audio parameters, e.g., activating/deactivating multiple parameters at once, changing parameters at certain events (e.g., turning a knob to a different control), setting or automatically tuning one or more parameters individually or simultaneously (e.g., automatically sliding one or more faders 10%), etc. The layout of the controls, soft keys and hot keys can be user-modified to accommodate specific user workflow and ergonomic preferences.

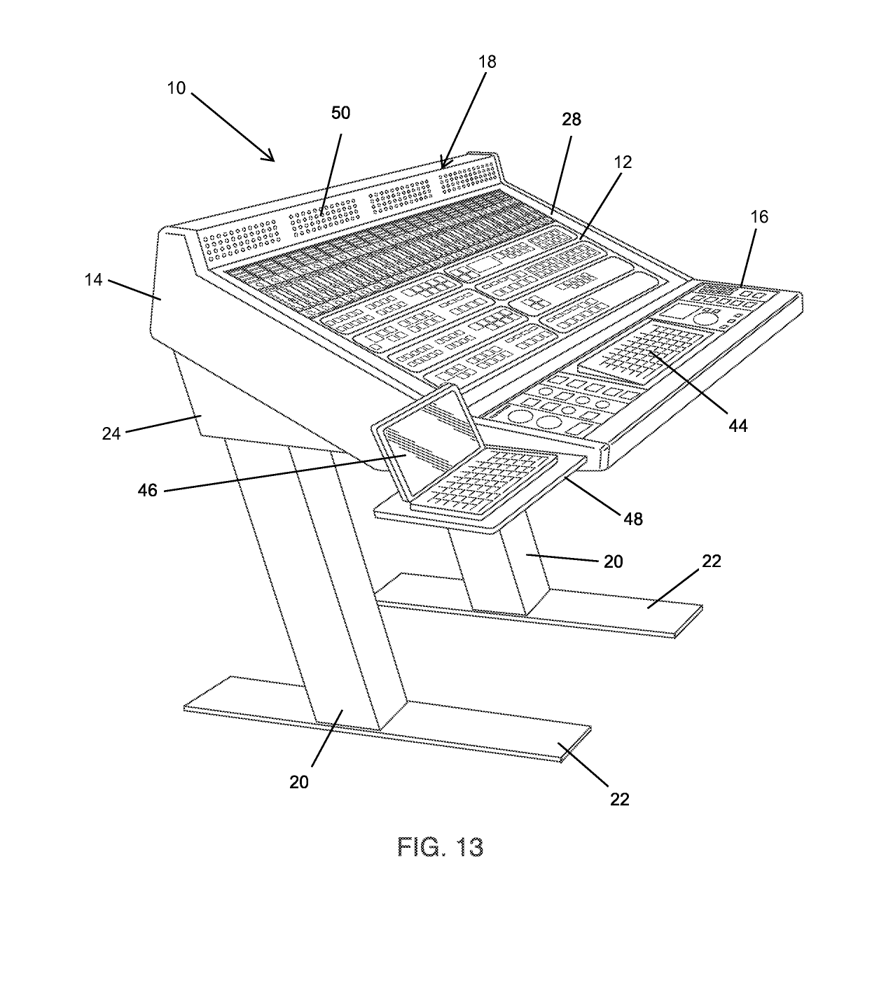

FIG. 13 illustrates another embodiment of the console panel 16, including an area for a keyboard 44 (e.g., an Apple extended keyboard), a trackball, trackpad, mousepad, or other computer input device. The use of a traditional computer keyboard and mouse may provide for better interaction with software suited for or programmed for these input devices (e.g., interaction with a Mac or Windows OS). For example, the keyboard is a great device for typing or completing text-based tasks, even in the DAW. In this respect, the audio production console 10 can be used with external computer equipment 46 such as a laptop, netbook, tablet or other portable computing device such as a smartphone. As mentioned above, the display 12 is preferably 46″ diagonally so as to adequately accommodate the range of parameter controls, but a person of ordinary skill in the art will recognize that other sizes may be used as well, depending on the desired use of the audio production console 10. The display 12 may also couple to a standalone computer via standard DVI-, VGA-, or HDMI-type interfaces.

The console panel 16 may supplement the touch-screen interface of the display 12 with a plurality of dedicated physical knobs, buttons and/or switches. These knobs, switches and/or button may optionally be organized into sections or groups. For example, the console panel 16 may include a talkback section that includes a studio button, a cue button and a level knob. This section may further include an on/off button that activates or deactivates a cue that may include one or more mixing options, a digital audio input, iDock or auxiliary audio input option. A second on/off button may determine whether to channel the cue to the studio. Similarly, the console panel 16 may include a phones section inclusive of an on/off button that activates or deactivates a phones knob wherein the user may select from one or more monitoring options, including Digital input, iDock, auxiliary or other options as known in the art. Furthermore, the console panel 16 may include a meters section having buttons for selecting various VU meter modes.

Central to the console panel 16 is the keyboard 44 that preferably includes an Apple Extended Keyboard or the like. Such a keyboard 44 preferably includes a QWERTY key layout and may further include a numeric keypad, depending on the space allocation or desired application or use. Furthermore, the Apple Extended Keyboard includes an ultrathin enclosure with low-profile keys and may include one or more function keys for one-touch access to a variety of Mac features, such as screen brightness, volume, eject, play/pause, fast-forward and rewind, Mission Control, and Launchpad. These keys may provide streamlined functionality and interaction with the console software and GUI 26. Extended layout keys such as page up, page down, home, and end, full-size arrow keys, etc. are preferably included with the keyboard 44 to provide additionally single-key input options. Additionally or alternatively, the keyboard 44 may include one or more data ports, such as low speed USB 1.0, USB 2.0 or the newer and faster 3.0 standard. Data ports allow users to connect external devices, such as mice, trackballs, or other high-speed digital audio equipment for use with the audio production console 10. Of course, comparable keyboards designed for use with the Microsoft Windows OS or operating system independent generic keyboards may also be used. Next to the keyboard 44 is an area designated to either incorporate or provide room for a computer input device such as the aforementioned mouse, trackball, touchpad, etc. The input device may typically include a single input device, such as the “point-and-click” input commonly associated with computer mice.

The console panel 16 described herein optionally further includes a master control panel that may include audio controls such as Mix1, Mix2, iDock, Digital, Cue, Aux1, Aux2, Source, or a plurality of settings for Cue. Other features may include Mono, Mute, Talk, Dim or a volume knob. A person of ordinary skill in the art will readily recognize that the master control panel may include a variety of audio control buttons, knobs, or other physical controls and interface jacks, such as any combination of those described above. Furthermore, the console panel 16 may also include a speaker panel and a 5.1 panel. The speaker panel may include a variety of buttons or audio control options. The 5.1 panel preferably includes options for controlling speakers that may be used in association with stereo and a 5.1 or 7.1 surround sound system, such as Dolby Digital, Dolby Pro Logic II, DTS or SDDS. The “5.1” is a common name for a six channel surround sound multichannel audio system. As shown, the 5.1 panel may also include an “on/off” button to activate and/or deactivate control operation or application of the 5.1 panel parameters. Of course, other surround sound formats could be used in association with the console panel 16 disclosed herein. Instead of the 5.1 panel, such a panel may include options for 6.1-channel surround sound such as DTS-ES, Dolby Digital EX and THX Surround EX; or 7.1-channel surround sound such as lossless surround sound formats incorporated into Blu-ray Discs (e.g., Dolby TrueHD and DTS-HS Master Audio).

Furthermore, the audio production console 10 preferably further includes a set of ports that may connect to an iPod, iPhone, iPad, laptop, netbook or other multimedia device or computer. In this respect, an optional tray 48, stand or other attachment may be positioned nearby or attach to the chassis 14 to support or provide a means for coupling the external computer 46 (e.g., the aforementioned iPod, iPhone or iPad) to the audio production console 10. These trays or attachments 48 will expand the physical work surface and better integrate such external hardware with the audio production console 10. Further components that may be integrated with the audio production console may include audio input and output jacks mounted on the outside of the chassis 14, multichannel artist headphone monitor mixers, and stereo speakers.

The meter bridge 18 at the top of the audio production console 10 may include an analog or digital Volume Unit (“VU”) meters and/or LED meters 50. The VU meter, sometimes called a Standard Volume Indicator (“SVI”), is a device that displays the representation of a signal level in audio equipment. Traditional audio production consoles used needle-based analog VU meters. The audio production console 10 disclosed herein may use said analog meters, or more preferably may represent the positioning of the needle in a digital environment, such as on an LCD or comparable digital display. In this embodiment, the user has the option to change the look and feel of the meter bridge 18, such as the number or size of the VU meters and/or the LED meters 50. Alternatively, the meter bridge 18 could be reconfigured to display other information pertinent to an audio parameter; or may display nothing at all. Preferably, the VU meters and/or the LED meters 50 provide real-time audio production information, such as audio signal levels.

Another feature of the console 10 is that it optionally includes an audio monitoring controller. The audio monitoring and routing controller is functionality reminiscent of a portion of an analog console, of what is typically referred to as the “center section.” The center section is able to select audio sources for playback and controls the playback volume of the selected source. Physical audio input and output jacks, analog circuit paths and physical knobs and buttons allow for connection, routing, selection and level control of audio signals on the console 10. In a common audio monitoring scenario, for example, a multichannel audio interface provides analog and digital audio paths to the DAW via a host computer. The main stereo analog outputs of the DAW connect via an audio cable to the input jack labeled “Mix 1.” The Mix 1 button may be activated, e.g., by depressing a button on the console panel 16 or the display 12. The button may illuminate to provide visual confirmation that the Mix 1 button has been activated. Activation routes the audio appearing at the Mix 1 input to the main volume control. A pair of the analog or digital VU meters may provide immediate visual notification of the routing. That same source can also be routed to and monitored via headphone outputs.

If a multichannel audio interface has more than two outputs (a typical interface has eight), additional outputs can be routed to headphone sub-mixers to allow recording artists and performers to control levels of multiple audio sources to create a preferred mix of relative levels. In essence, this allows each recording artist or performer to develop a unique monitoring reference. In this respect, the audio monitoring controller is able to accept and select a variety of analog and digital audio sources, then route those sources to various audio for monitoring at varying levels and proportions through speakers and headphones and recording devices.

Although several embodiments have been described in detail for purposes of illustration, various modifications may be made without departing from the scope and spirit of the invention. Accordingly, the invention is not to be limited, except as by the appended claims.

What is claimed is:

1. An audio production console, comprising:
a monitor for displaying an interactive graphical user interface having at least two on-screen audio controls;
a multi-touch sensing system for simultaneously locating and tracking at least two input events respectively corresponding with said at least two on-screen audio controls displayed by said interactive graphical user interface;
an audio controller for associating said input events located and tracked by said multi-touch sensing system with respective audio control parameters represented graphically as said on-screen audio controls by said interactive graphical user interface; and
a feedback controller for adjusting an audio track in response to changes to said audio control parameters linked to movement of said on-screen audio controls as part of said input events located and tracked by said multi-touch sensing system.

2. The audio production console of claim 1, wherein said multi-touch sensing system includes a plurality of light emitters and a respective plurality of light detectors disposed around a periphery of said monitor, wherein said light emitters generate a light beam for reception by said light detectors.

3. The audio production console of claim 2, wherein said light beams create a grid over said monitor.

4. The audio production console of claim 1, wherein said sensing system comprises an infrared sensing system or a capacitive sensing system.

5. The audio production console of claim 1, wherein said monitor includes a nanotechnology glass coating comprising a thickness less than or equal to 2 millimeters.

6. The audio production console of claim 1, wherein said on-screen audio controls comprise a knob, a fader, or a button.

7. The audio production console of claim 1, including a hot key for simultaneously adjusting multiple audio control parameters.

8. The audio production console of claim 1, wherein said monitor comprises an LCD display having an at least 46 inch diagonal screen.

9. The audio production console of claim 1, wherein said graphical user interface includes a panel virtually movable as part of an input event, wherein said panel includes multiple on-screen audio controls.

10. The audio production console of claim 1, including a meter bridge extending out from a chassis supporting said monitor and said multi-touch sensing system.

11. The audio production console of claim 10, wherein said chassis supports said monitor at an angle between 30 and 40 degrees.

12. The audio production console of claim 10, including a console panel extending out from said chassis and generally positioned horizontally to suppose an input device.

13. An audio production console, comprising:
a chassis supporting a monitor for displaying an interactive graphical user interface having at least two on-screen audio controls, wherein said chassis includes a meter bridge;
a multi-touch sensing system supported by said chassis and including a plurality of light emitters and a respective plurality of light detectors disposed around a periphery of said monitor, wherein said light emitters generate a light beam for reception by said light detectors for simultaneously locating and tracking at least two input events respectively corresponding with said at least two on-screen audio controls displayed by said interactive graphical user interface;
an audio controller for associating said input events located and tracked by said multi-touch sensing system with respective audio control parameters represented graphically as said on-screen audio controls by said interactive graphical user interface; and
a feedback controller for adjusting an audio track in response to changes to said audio control parameters linked to movement of said on-screen audio controls as part of said input events located and tracked by said multi-touch sensing system.

14. The audio production console of claim 13, wherein said sensing system comprises an infrared sensing system having a plurality of infrared light beams that create a grid over said monitor.

15. The audio production console of claim 13, wherein said monitor includes a nanotechnology glass coating comprising a thickness less than or equal to 2 millimeters and said on-screen audio controls comprise a knob, a fader, a button or a hot key for simultaneously adjusting multiple audio control parameters.

16. The audio production console of claim 13, wherein said chassis includes a generally horizontal console panel and supports said monitor comprising an LCD display having an at least 46 inch diagonal screen at an angle between 30 and 40 degrees.

17. The audio production console of claim 13, wherein said graphical user interface includes a panel virtually movable as part of an input event, wherein said panel includes multiple on-screen audio controls.

18. An audio production console, comprising:
a chassis supporting a monitor for displaying an interactive graphical user interface having at least two on-screen audio controls comprising a knob, a fader, a button or a hot key, wherein said chassis includes a meter bridge;
a multi-touch infrared sensing system supported by said chassis and including a plurality of infrared light emitters and a respective plurality of infrared light detectors disposed around a periphery of said monitor, wherein said infrared light emitters generate an infrared light beam for reception by said light detectors for simultaneously locating and tracking at least two input events respectively corresponding with said at least two on-screen audio controls displayed by said interactive graphical user interface, said infrared light beams forming a grid over said monitor;
an audio controller for associating said input events located and tracked by said multi-touch sensing system with respective audio control parameters represented graphically as said on-screen audio controls by said interactive graphical user interface; and
a feedback controller for adjusting an audio track in response to changes to said audio control parameters linked to movement of said on-screen audio controls as part of said input events located and tracked by said multi-touch sensing system.

19. An audio production process, including the steps of:
displaying an interactive graphical user interface having at least two on-screen audio controls on a monitor;
simultaneously locating and tracking at least two input events with a sensing system associated with said monitor, said input events respectively corresponding with said at least two on-screen audio controls displayed by said interactive graphical user interface;
associating said located and tracked input events with respective audio control parameters represented graphically as said on-screen audio controls by said interactive graphical user interface; and
adjusting an audio track in response to changes to said audio control parameters linked to movement of said on-screen audio controls as part of said located and tracked input events.

20. The process of claim 19, including the step of simultaneously measuring movement of said input events over said monitor and changing said respective audio control parameters relative to said measurements.

21. The process of claim 19, including the step of synchronizing movement of said on-screen audio controls to changes in said audio control parameters.

22. The process of claim 19, including the step of assigning an on-screen audio control to a different audio control parameter.

23. The process of claim 19, including the step of generating a grid of interruptible infrared light beams over a surface of said display with said sensing system.

24. The process of claim 19, including the step of relocating a panel carrying a plurality of said on-screen audio controls.
